(19) United States
(12) Patent Application Publication
(10) Pub. No.: US 2009/0100497 A1
(43) Pub. Date: Apr. 16, 2009

(54) METHOD AND APPARATUS FOR PREVENTING A SET OF USERS FROM ACCESSING A MESSAGE IN AN INSTANT MESSAGING SYSTEM

(76) Inventors: Itzhack Goldberg, Hadera (IL); Ido Guy, Haifa (IL); Boaz Mizrachi, Haifa (IL); Vladimir Soroka, Karmiel (IL)

Correspondence Address: DUKE W. YEE, YEE & ASSOCIATES, P.C, P.O BOX 802333, DALLAS, TX, 75380, US

(21) Appl. No.: 11/870,602

(22) Filed: Oct. 11, 2007

(51) Int. Cl. G06F 21/24

(52) U.S. Cl. 726/1

(57) ABSTRACT

The illustrative embodiments described herein provide a computer-implemented method, apparatus, and computer program product for preventing a set of users from accessing a message in an instant messaging system. The process determines whether a message received by a receiving computing device from a sending computing device is undetected by a set of users associated with the receiving computing device. The process notifies the sending computing device that the message is undetected by the set of users in response to determining that the message is undetected by the set of users associated with the receiving computing device. The process prevents the set of users from accessing the message in response to receiving a request to prevent the set of users from accessing the message.

### BACKGROUND OF THE INVENTION

1. Field of the Invention

The present invention relates generally to a data processing system and in particular to a method and apparatus for preventing a set of users from accessing a message. More particularly, the present invention is directed to a computer-implemented method, apparatus, and computer-usable program code for preventing a set of users from accessing a message in an instant messaging system.

2. Description of the Related Art

An instant messaging system is an online chat medium, allowing users to communicate with each other and collaborate in real-time over a network data processing system. Instant messaging is commonly used over the Internet. Instant messaging systems monitor and report the status of users that have established each other as online contacts. This information is typically presented to a user in a window. Instant messaging systems are also often used by users conducting business. By utilizing instant messaging, business users can view each other's availability and initiate a text conversation with colleagues or customers when a desired contact becomes available. Non-limiting examples of instant messaging systems include AOL Instant Messenger, MSN Messenger, Yahoo! Messenger, Google Talk, and MySpace IM. AOL Instant Messenger is a product of AOL LLC. MSN Messenger is a product of Microsoft Corporation. Yahoo! Messenger is a product of Yahoo! Inc. Google Talk is a product of Google Inc. MySpace IM is owned by News Corporation.

Typically, with instant messaging systems, communication between users is initiated by users selecting the name of the person with which they desire to communicate. Then, the users type messages in a dialog box in the window and press “send”. These messages appear instantly on the selected recipient's computer.

Until now, instant messaging has been developed largely for home users, but used by home and business users alike. Instant messaging allows an organization to deploy and utilize this “need-to-have” technology in a business setting.

At times, a user may desire to censor, edit, or delete a message that is intended for another user in an instant messaging system. For example, the user may determine that the message is addressed to the wrong recipient, contains a typographical error, or contains undesirable content.

One current method for allowing a user to censor, edit, or delete a message in an instant messaging system slows down the delivery of the message that is intended for another user. In this method, the instant message system may provide a “reflection window” that allows a user to censor, edit, or delete message content before sending the message to the intended recipient. However, this method requires that the user censor, edit, or delete message content before the message is sent. The method does not address the situation in which the user desires to censor, edit, or delete message content after sending the message. For example, this current method fails to allow a user to censor, edit, or delete message content in a message that was inadvertently sent by a user.

Some asynchronous messaging systems, including e-mail applications such Microsoft® Outlook, and semi-synchronous messaging systems, such as Skype, allow a user to recall a message that has not been opened by a recipient of the message. Microsoft and Outlook are trademarks of Microsoft Corporation in the United States, other countries, or both. However, these asynchronous messaging systems do not take into account the synchronous or semi-synchronous aspect of instant messaging systems. The synchronous or semi-synchronous aspect of messaging systems, such as an instant messaging system, allows real-time collaboration between users in which messages are immediately viewable by each message recipient. Recalling methods in asynchronous messaging systems, however, are not adapted for recalling messages that are immediately viewable in real-time.

### SUMMARY OF THE INVENTION

The illustrative embodiments described herein provide a computer-implemented method, apparatus, and computer program product for preventing a set of users from accessing a message in an instant messaging system. The process determines whether a message received by a receiving computing device from a sending computing device is undetected by a set of users associated with the receiving computing device. The process notifies the sending computing device that the message is undetected by the set of users in response to determining that the message is undetected by the set of users associated with the receiving computing device. The process prevents the set of users from accessing the message in response to receiving a request to prevent the set of users from accessing the message.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network data processing system in which the illustrative embodiments may be implemented;

FIG. 2 is a block diagram of a data processing system in which the illustrative embodiments may be implemented;

FIG. 3 is a diagram illustrating components used in an instant messaging system in accordance with an illustrative embodiment;

FIG. 4 is a block diagram of a system for preventing a set of users from accessing a message in an instant messaging system in accordance with an illustrative embodiment;

FIG. 5 is a block diagram of a system for preventing a set of users from accessing a message in an instant messaging system in accordance with an illustrative embodiment;

FIG. 6 is a flowchart illustrating a process for preventing a set of users from accessing a message in an instant messaging system in accordance with an illustrative embodiment; and

FIG. 7 is a flowchart illustrating a process for preventing a set of users from accessing a message in an instant messaging system in accordance with an illustrative embodiment.

### DETAILED DESCRIPTION OF THE PREFERRED EMBODIMENT

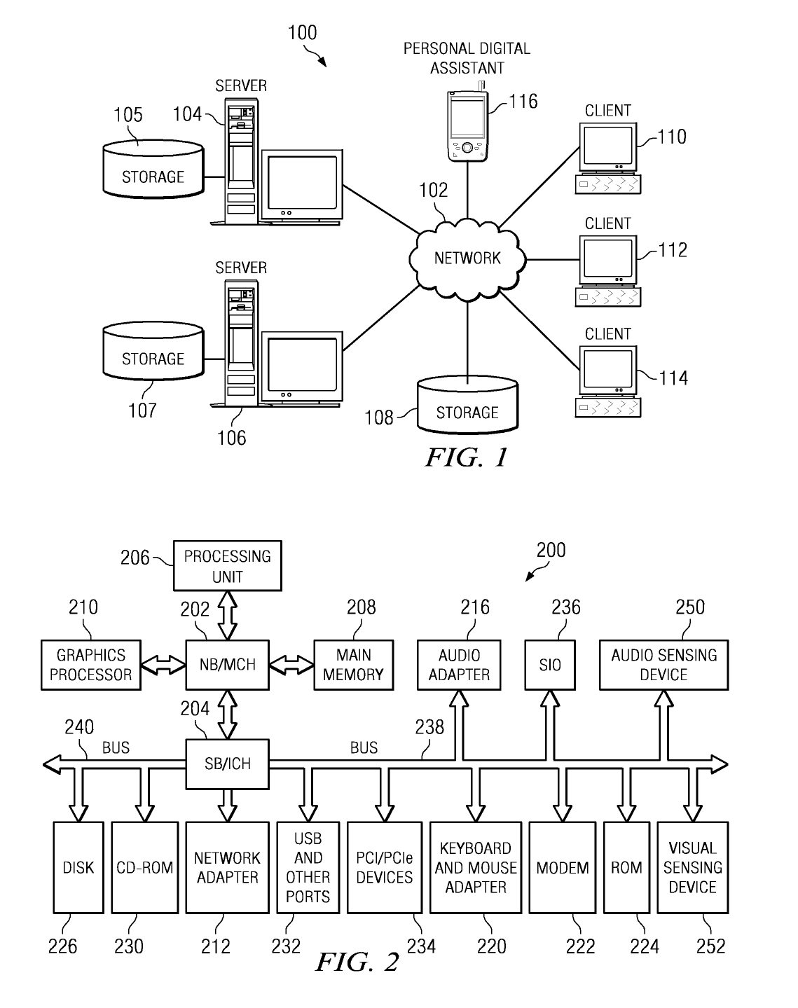

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. Servers 104 and 106 also have their own respective storage units 105 and 107. In addition, clients 110, 112, and 114 and personal digital assistant 116 connect to network 102. Clients 110, 112, and 114 may be, for example, personal computers or network computers. Personal digital assistant 116 may be any mobile or handheld computing device, such as a cell phone or PalmPilot™. Clients 110, 112, and 114 and personal digital assistant 116 may include an instant messaging system that may be used to correspond with others in real-time over network 102.

In the depicted example, server 104 provides data, such as boot files, operating system images, and applications to clients 110, 112, and 114. Servers 104 and 106 may also host an instant messaging system that allows correspondence amongst clients 110, 112, and 114 and personal digital assistant 116. This instant messaging system may be implemented using different illustrative embodiments. Clients 110, 112, and 114 and personal digital assistant 116 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. For example, data processing system 200 may contain and execute computer-usable program code for an instant messaging system.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240.

Data processing system 200 includes audio sensing device 250, which is coupled to interface and I/O controller hub 204 through bus 238. Audio sensing device 250 is any device that detects sound, such as a microphone. Audio sensing device 250 may also convert detected sounds into electrical signals and transmit those signals to other components in data processing system 200.

Data processing system 200 includes visual sensing device 252, which is coupled to interface and I/O controller hub 204 through bus 238. Visual sensing device 252 is any device that detects light, such as a camcorder, camera, webcam, or photodiode. Visual sensing device 252 may also convert detected light into electrical signals and transmit those signals to other components in data processing system 200.

PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer-implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

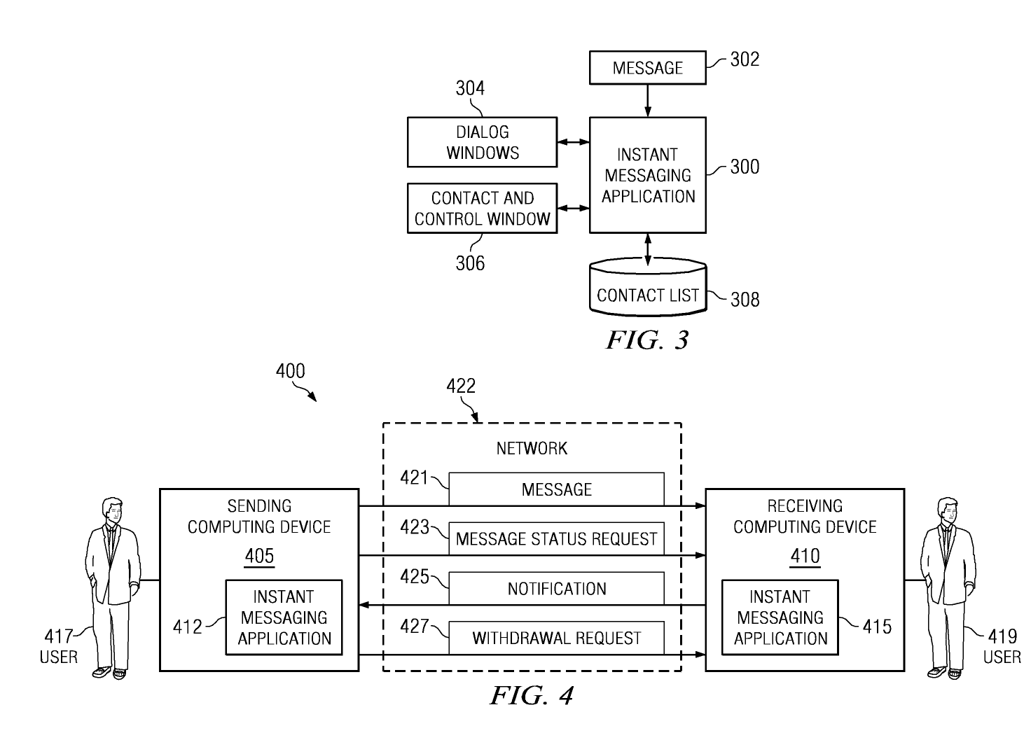

Turning next to FIG. 3, a diagram illustrating components used in an instant messaging system are depicted in accordance with an illustrative embodiment. Instant messaging application 300 may be implemented on a data processing system, such as servers 104 and 106, clients 110, 112, and 114, and personal digital assistant 116 in FIG. 1, or data processing system 200 in FIG. 2. Also, instant messaging application 300 may be a single instance of an instant messaging application in a larger instant messaging system that includes a plurality of instant messaging applications.

In the depicted example, instant messaging application 300 processes messages, such as message 302, received from users located on remote data processing systems. As messages are received, these messages are presented in dialog windows 304. In some instances, dialog windows 304 may not be displayed on a graphical user interface at a particular point in time. A graphical user interface is any device that displays data, such as a monitor, touchscreen, projection, or arrangement of light. For example, dialog windows 304 may be minimized or hidden behind dialog windows for other applications. Additionally, dialog windows 304 may not be displayed if a screen saver is executing on the graphical user interface. Messages exchanged between instant messaging application 300 and an instant messaging application on a remote data processing system form a conversation in these examples.

Additionally, dialog windows 304 provide an interface for user input to send messages to other users. Contact and control window 306 is presented by instant messaging application 300 to provide the user with a list of user names, as well as other information, such as, for example, identifying other users that are currently online. Contact and control window 306 also provides an interface to allow the user to set different preferences. For example, the user may set passwords required to access different names used in instant messaging sessions. Further, a user may employ contact and control window 306 to set other preferences, such as colors and fonts used in instant messaging application 300. Contact and control window 306 may also receive notification as to whether a message that has been sent to an intended recipient had been detected by the intended recipient.

Further, the list of names presented by contact and control window 306 is stored in contact list 308 in these examples. Additional user names may be added or deleted from contact list 308. This contact list is employed in presenting the list of names within contact and control window 306. Additionally, the user may view the status of other users on contact and control window 306. This status may be, for example, available or busy. When the status is available, instant messaging application 300 will accept messages from another instant messaging application to start a new conversation. When the status of another user is busy, messages from instant messaging application 300 are not accepted by the other application for that user.

The illustrative embodiments described herein provide a computer-implemented method, apparatus, and computer program product for preventing a set of users from accessing a message in an instant messaging system. A set of users is one or more users. A message is any data capable of being transmitted in any medium.

In one embodiment, the process detects receipt of the message at a receiving computing device. A receiving computing device is any computing device capable of receiving a message. For example, a receiving computing device may receive a message in an instant messaging system. The message is sent by a sending computing device. A sending computing device is any computing device capable of sending a message. For example, a sending computing device may send a message in an instant messaging system. The process determines whether a message received by a receiving computing device from a sending computing device is undetected by a set of users associated with the receiving computing device.

The process also notifies the sending computing device that the message is undetected by a set of users associated with the receiving computing device. A set of users may be associated with the receiving computing device if they are the intended recipient of the message received at the receiving computing device. In another example, the set of users may be associated with the receiving computing device if the set of users is executing or logged into an instant messaging application on the receiving computing device. A set of users may also be associated with the receiving computing device if the receiving computing device is accessible to the set of users. For example, the set of users may have authorization to use the receiving computing device either directly or from a remote location. In another example, the receiving computing device is accessible to the set of users if the receiving computing device is located in the vicinity of the set of users. In this example, the receiving computing device may be in the vicinity of the set of users if the receiving computing device is in the same house, office, building, or city as the set of users.

The process may notify the sending computing device that the message is undetected by a set of users associated with the receiving computing device in response to determining that the message is undetected by the set of users. In one embodiment, the process that notifies the sending computing device that the message is undetected by a set of users associated with the receiving computing device may also be in response to a message status request from the sending computing device. A message status request is any request for the status of a message. In one example, the message status request is a query from the sending computing device as to whether a set of users at the receiving computing device has detected one or more messages sent from the sending computing device.

The process may determine that the message is “undetected” by the set of users in a variety of ways. In one embodiment, the process determines that the message is undetected by the set of users by detecting an absence of the set of users at the receiving computing device. An “absence” of the set of users is detected when data that is acquired by a sensing device indicates that the set of users is beyond a threshold distance from the receiving computing device. Alternatively, an “absence” of the set of users may be detected by a lack of data being acquired by a sensing device.

In one example, the absence is detected by a visual or audio sensing device. In another example, an absence of the set of users at the receiving computing device is detected when the process detects an absence of a mobile device carried by the user. A mobile device is any device that may be carried by the set of users, such as a cellular phone, pager, PalmPilot, personal digital assistant, keychain, wallet, and Bluetooth enabled device.

In another embodiment, the process determines that the message is undetected by the set of users by detecting a location and movement of the mobile device carried by the set of users. The process uses the detected location and movement of the mobile device to determine that the message is undetected by the set of users. For example, the process may detect that the mobile device is moving away from the receiving computing device at a location beyond a viewing distance between the set of users and receiving computing device. In another example, the location and the movement are detected using Bluetooth. Bluetooth is an industrial specification for wireless personal area networks.

In another embodiment, the process determines that the message is undetected by the set of users by identifying a physical orientation of the set of users. A physical orientation is the location and movement of the body parts of the set of users. The physical orientation may be identified by a visual sensing device. In this embodiment, the process determines that the message is undetected by the set of users based on the physical orientation of the set of users. For example, the process may determine that the message is undetected by the set of users if the physical orientation of the set of users indicates that the set of users is not looking at a graphical user interface of the receiving computing device. A visual sensing device may be used in this example in such a way that the visual sensing device can detect whether the eyes of the set of users are directed away from the graphical user interface.

In another embodiment, the process determines that the message is undetected by the set of users by determining that the message is not displayed on a graphical user interface on the receiving computing device. For example, the message may not be displayed on a graphical user interface on the receiving computing device because the dialog windows containing the message are minimized. In this example, the dialog windows may also be concealed or partially concealed by another window, a screen saver, or any other graphical object on the graphical user interface.

In another embodiment, the process may determine that the message is not displayed on the graphical user interface on the receiving computing device by determining that a graphical display for the instant messaging system is not displayed on the graphical user interface. A graphical display for the instant messaging system is any displayable set of data about the instant messaging system. The displayable set of data may be a window that contains data about the instant messaging system, such as dialog windows 304 and contact and control window 306 in FIG. 3.

In one embodiment, the process determines that the message is not displayed on a graphical user interface on the receiving computing device based on data received from the operating system of the receiving computing device. Alternatively, this determination may be based on data received from the instant messaging application.

The process also prevents the set of users associated with the receiving computing device from accessing the message in response to receiving a request to prevent the set of users from accessing the message. The set of users does not have “access” to the message if the set of users are unable to view the message. In an alternate embodiment, the set of users does not have “access” to the message if the set of users are unable to view or detect any indication on a graphical user interface that the message has been sent.

In one embodiment, the process prevents the set of users associated with the receiving computing device from accessing the message by preventing the set of users from accessing the message on a graphical user interface. In another embodiment, the process prevents the set of users associated with the receiving computing device from accessing the message by removing the message from the graphical user interface. For example, the message may be removed from an ‘inbox’ of the instant messaging application at the receiving computing device.

Turning now to FIG. 4, a block diagram of a system for preventing a set of users from accessing a message in an instant messaging system is depicted in accordance with an illustrative embodiment. Specifically, FIG. 4 shows network data processing system 400, on which an instant messaging system is implemented.

Network data processing system 400 includes sending computing device 405 and receiving computing device 410. Sending computing device 405 and receiving computing device 410 may be any computing device on which an instant messaging application may be executed, such as servers 104 and 106, clients 110, 112, and 114, and personal digital assistant 116 in FIG. 1, or data processing system 200 in FIG. 2. Although network data processing system 400 includes a single sending computing device 405 and a single receiving computing device 410, network data processing system 400 may include any number sending computing devices and receiving computing devices.

Sending computing device 405 and receiving computing device 410 each contain instant messaging applications 412 and 415, respectively. Instant messaging applications 412 and 415 are each part of the instant messaging system implemented on network data processing system 400. Instant messaging applications 412 and 415 are non-limiting examples of instant messaging application 300 in FIG. 3. Any number of instant messaging applications may be included on each of sending computing device 405 and receiving computing device 410.

Users 417 and 419 operate instant messaging applications 412 and 415, respectively. For example, users 417 and 419 may be logged into instant messaging applications 412 and 415, respectively, using users 417 and 419 respective accounts for the instant messaging system. Instant messaging applications 412 and 415 allow users 417 and 419 to communicate with one another in real-time. Although instant messaging applications 412 and 415 are each shown to be operated by a single user, any number of users may operate each of instant messaging applications 412 and 415.

In one embodiment, user 417 sends message 421 to receiving computing device 410 using instant messaging application 412. Receiving computing device 410 detects receipt of message 421. Message 421, and all other communications between sending computing device 405 and receiving computing device 410, is transmitted over network 422. Network 422 is a non-limiting example of network 102 in FIG. 1. Alternatively, message 421, and all other communications between sending computing device 405 and receiving computing device 410, may be transmitted via a direct connection between sending computing device 405 and receiving computing device 410.

User 417 then sends message status request 423 to receiving computing device 410. Message status request 423 is a request for the status of message 421. In particular, message status request 423 may be a query for whether user 419 has detected message 421.

Upon receiving message status request 423, receiving computing device 410 determines whether message 421 has been detected by user 419. In one embodiment, receiving computing device 410 determines whether message 421 has been detected by user 419 by detecting a location, movement, or absence of user 419. In another embodiment, receiving computing device 410 determines whether message 421 has been detected by user 419 by determining whether message 421 has been displayed on a graphical user interface for receiving computing device 410.

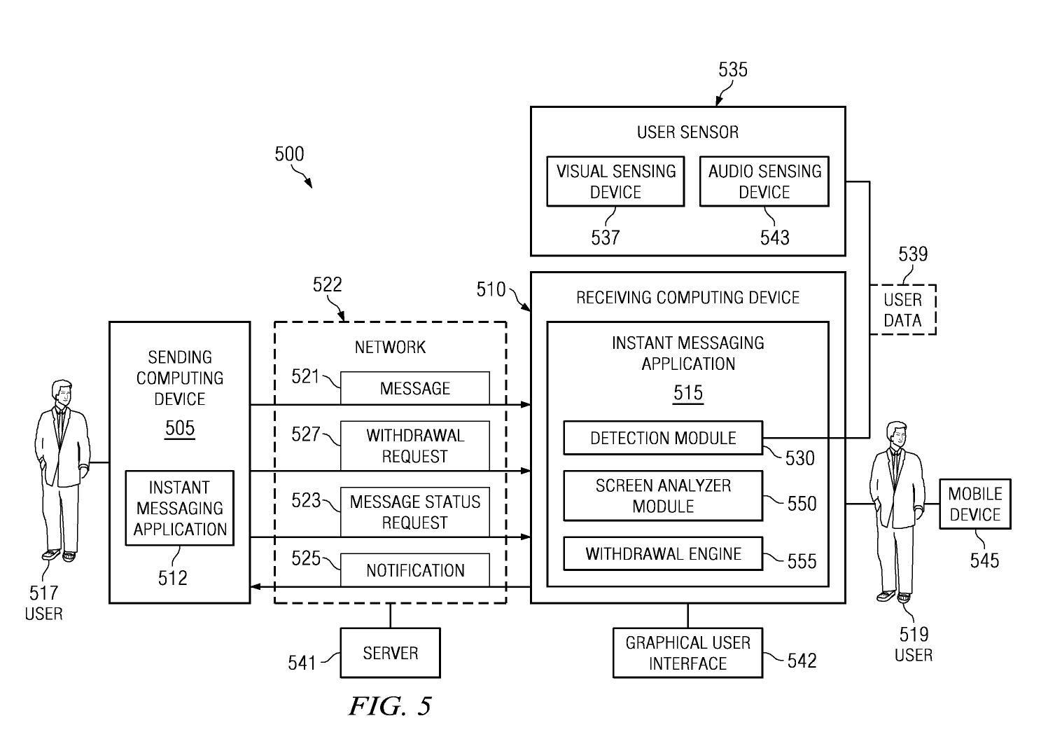

Receiving computer device 410 may determine whether message 421 is detected by user 419 at any time. For example, receiving computer device 410 may determine whether message 421 is detected by user 419 at the time message 421 is received at receiving computing device 410. In another example, receiving computer device 410 may determine whether message 421 is detected by user 419 at the time message status request 423 or withdrawal request 427 is received at receiving computing device 410. Furthermore, receiving computer device 410 may determine whether message 421 is detected by user 419 during any time span, such as between the time message 421 is received and the time that message status request 423 or withdrawal request 427 is received. The process for determining whether message 421 has been detected by user 419 will be discussed in greater detail with respect to FIG. 5 below.

In response to determining that message 421 is undetected by user 419, receiving computing device 410 sends notification 425 to sending computing device 405. Notification 425 notifies sending computing device 405 that message 421 is undetected by user 419. Sending computing device 405 may apprise user 417 of the receipt of notification 425. In an alternative embodiment, instead of sending notification 425 in response to message status request 423, receiving computing device 410 sends notification 425 to sending computing device 405 for every message that is undetected by user 419.

Upon receiving notification 425, or at any other time, user 417 may send withdrawal request 427 to receiving computing device 410. Withdrawal request 427 is a request to prevent user 419 from accessing message 421. Receiving computing device 410 may then prevent user 419 from accessing message 421 on receiving computing device 410.

Turning now to FIG. 5, a block diagram of a system for preventing a set of users from accessing a message in an instant messaging system is depicted in accordance with an illustrative embodiment. Specifically, FIG. 5 shows, in greater detail, a non-limiting example of the instant messaging system in network data processing system 400 in FIG. 4. In one embodiment, the instant messaging system, including the coordination of data transfer between sending computing device 505 and receiving computing device 510, is implemented by server 541. Server 541 is a data processing system, and a non-limiting example of servers 104 and 106 in FIG. 1. In addition, server 541 may also contain software that facilitates the implementation or hosting of the instant message system.

User 517 sends message 521 to receiving computing device 510 over network 522 using instant messaging application 512 in sending computing device 505. Receiving computing device 510 determines whether message 521 is detected by user 519. In particular, detection module 530 of instant messaging application 515 determines whether message 521 is detected by user 519. Although FIG. 5 shows that instant messaging application 515 determines whether message 521 is detected by user 519, any hardware or software component of receiving computing device 510, as well as server 541, may determine whether message 521 is detected by user 519.

In one example, detection module 530 may determine whether each message received by receiving computing device 510 has been detected by user 519. In another embodiment, detection module 530 determines whether a particular message has been detected by user 519 only when a message status request has been sent to receiving computing device 510 for that particular message.

Detection module 530 may determine whether message 521 is detected by user 519 in a variety of ways. In one embodiment, detection module 530 determines that message 521 is undetected by user 519 by detecting an absence of user 519 at receiving computing device 510. The absence of user 519 is detected by user sensor 535.

User sensor 535 includes visual sensing device 537. Visual sensing device 537 is any device that detects light, such as a camcorder, camera, webcam, or photodiode. Any visual input obtained by visual sensing device 537 is sent to detection module 530 as user data 539. Detection module 530 may then detect an absence of user 519 based on user data 539 from visual sensing device 537. For example, detection module 530 may detect an absence of user 519 if visual sensing device 537 does not obtain any input indicating that user 519 is within a viewing threshold distance of receiving computing device 510. The viewing threshold distance is a predetermined distance from receiving computing device 510 beyond which user 519 is determined to be absent from receiving computing device 510. The viewing threshold distance may be set by user 517, user 519, server 541, a developer, or any combination thereof. In this example, visual sensing device 537 may also detect a lack of any movement in a particular area around receiving computing device 510. The particular area monitored by visual sensing device 537 may be set by user 517, user 519, server 541, a developer, or any combination thereof. For example, the particular area may be an area in front of graphical user interface 542.

In another example, visual sensing device 537 may take a picture of a particular area around receiving computing device 510, such as the area customarily occupied by user 519, and determine whether the picture includes user 519. If the picture fails to include user 519, or if the picture indicates that user 519 is beyond a viewing threshold distance from receiving computing device 510, then detection module 530 detects an absence of user 519.

User sensor 535 also includes audio sensing device 543. Audio sensing device 543 is any device that detects sound, such as a microphone. Audio sensing device 543 may also be a voice synthesizer that allows user 519 to generate messages to be delivered in instant messaging system. Detection module 530 may detect an absence of user 519 based on user data 539 from audio sensing device 543. For example, detection module 530 may detect an absence of user 519 if audio sensing device 543 fails to detect voice input from user 519. Detection module 530 may also detect an absence of user 519 if audio sensing device 543 does not receive any audio input. In the example in which audio sensing device 543 is a voice synthesizer for instant messaging application 515, detection module 530 may also detect an absence of user 519 if the voice synthesizer does not receive any voice input.

Detection module 530 may also use a combination of visual sensing device 537 and audio sensing device 543 to detect an absence of user 519. For example, detection module 530 may detect any absence of user 519 if visual sensing device 537 fails to visually detect any presence of user 519 and audio sensing device 543 fails to receive any audio input from user 519. The relative weight given to user data 539 from each of visual sensing device 537 and audio sensing device 543 may be set by user 517, user 519, server 541, a developer, or any combination thereof. For example, user 517 may direct detection module 530 to increase the viewing threshold distance beyond which detection module 530 detects an absence of user 519 if audio sensing device 543 receives any voice input from user 519.

In an alternate embodiment, user sensor 535 may include a heat sensor that detects body heat from a user, such as user 519. In this embodiment, detection module 530 detects an absence of user 519 if the heat sensor fails to detect any body heat from a user.

In another alternative embodiment, detection module 530 may also detect the movement of components of receiving computing device 510. For example, detection module 530 may receive data from a component, such as an operating system, of receiving computing device 510 that indicates the movement of a mouse, keyboard, or other user interface for receiving computing device 510. In this embodiment, detection module 530 may detect an absence of user 519 if detection module 530 receives no indication that user 519 has moved any such components of receiving computing device 510.

In another embodiment, using user sensor 535, detection module 530 may also identify a physical orientation of user 519. A physical orientation is the location and movement of the body parts of user 519. In this embodiment, detection module 530 may use user sensor 535 to determine whether user 519 has detected message 521 even when user 519 is not absent from receiving computing device 510. For example, detection module 530 may identify an orientation of the eyes of user 519. In another example, detection module 530 may identify that user 519 is walking away or moving away from receiving computing device 510.

Once detection module 530 has identified the physical orientation of user 519, detection module 530 may then determine that message 521 is undetected by user 519 based on the physical orientation of user 519. For example, detection module 530 may determine that message 521 is undetected by user 519 if user sensor 535 detects that the eyes of user 519 are not directed at graphical user interface 542. In another example, detection module 530 may determine that message 521 is undetected by user 519 if user sensor 535 detects that user 519 is walking away or moving away from receiving computing device 510 such that the eyes of user 519 are not pointed toward graphical user interface 542. Non-limiting reasons for the eyes of user 519 being directed away from graphical user interface 542 include user 519 talking to another person or performing an activity that directs the attention of user 519 away from graphical user interface 542.

In one embodiment, user 519 carries mobile device 545. A mobile device is any device that may be carried by the set of users, such as a cellular phone, pager, PalmPilot, personal digital assistant, keychain, wallet, or Bluetooth enabled device. In this embodiment, detection module 530 may use mobile device 545 to detect whether user 519 has detected message 521. For example, detection module 530 may detect an absence of user 519 at receiving computing device 510 by detecting an absence of mobile device 545. In this example, user sensor 535 and mobile device 545 may use Bluetooth technology. Using Bluetooth technology in user sensor 535 and mobile device 545, detection module 530 may detect when mobile device 545 is beyond a viewing threshold distance, or when mobile device 545 is at a distance that exceeds the distance at which Bluetooth technology can transmit signals to another device.

In another embodiment, using user sensor 535, detection module 530 detects a location and movement of mobile device 545, which is carried by user 519. Detection module 530 may then use the location and movement of mobile device 545 to determine that message 521 is undetected by user 519. For example, if user sensor 535 senses that mobile device 545 is moving away from receiving computing device at or above a predetermined threshold speed, then detection module 530 may determine that user 519 has not detected message 521. The location and the movement of mobile device 545 may be detected using Bluetooth technology.

Receiving computing device 510 also includes screen analyzer module 550. Screen analyzer module 550 may also determine whether message 521 is undetected by user 519. In one embodiment, screen analyzer module 550 determines that message 521 is undetected by user 519 if screen analyzer module 550 determines that message 521 is not displayed on graphical user interface 542. For example, message 521 may not be displayed on graphical user interface 542 because message 521 is concealed or partially concealed by another window, a screen saver, or any other graphical object on graphical user interface 542. In another example, message 521 may not be displayed on graphical user interface 542 because message 521 failed to appear on graphical user interface 542 at all.

In another embodiment, screen analyzer module 550 may determine that message 521 is not displayed on graphical user interface 542 by determining that a graphical display for instant messaging system is not displayed on graphical user interface 542. A graphical display for the instant messaging system is any displayable set of data about instant messaging system implemented in data processing system 500. In one example, the graphical display includes an ‘inbox’ for instant messaging application 515. The displayable set of data may be a window that contains data about the instant messaging system, such as dialog windows 304 and contact and control window 306 in FIG. 3.

In one example, screen analyzer module 550 may determine that a graphical display, such as an instant messaging window, for instant messaging system is not displayed on graphical user interface 542 because the graphical display that contains message 521 is minimized. In this example, the dialog window may also be concealed or partially concealed by another window, a screen saver, or any other graphical object on graphical user interface 542. The state of the graphical display or dialog window may be obtained from instant messaging application 515 or the operating system of receiving computing device 510.

Screen analyzer module 550 may detect whether message 521 or a graphical display for the instant messaging system has been displayed on graphical user interface 542 in a variety of ways. For example, screen analyzer module 550 may capture one or more screens on graphical user interface 542 and analyze the one or more captured screens to determine whether message 521 is displayed on graphical user interface 542. In another example, screen analyzer module 550 may obtain the state of the graphical display for the message or instant messaging system from the operating system of data processing system 500. Screen analyzer module 550 may then use this obtained state to determine whether message 521 or the graphical display has been displayed on graphical user interface 542.

In response to determining that message 521 is undetected by user 519, receiving computing device 510 notifies either or both of sending computing device 505 and user 517 that message 521 is undetected by user 519. For example, as previously exemplified in FIG. 4, receiving computing device 510 may send notification 525 to sending computing device 505. Notification 525 may additionally be in response to receiving message status request 523, provided that user 519 has not detected message 521.

Upon receiving notification 525, or at any other time, user 517 may send withdrawal request 527 to receiving computing device 510. Withdrawal engine 555 may then prevent user 519 from accessing message 521 on receiving computing device 510. In one embodiment, withdrawal engine 555 prevents user 519 from accessing message 521 on graphical user interface 542. In this embodiment, withdrawal engine 555 may prevent message 521 from being displayed on graphical user interface 542. In another example, withdrawal engine 555 may remove message 521 from graphical user interface 542. In this example, withdrawal engine 555 may remove message 521 from a graphical display of the instant messaging system, such as the ‘inbox’ portion of the graphical display.

In an alternate embodiment, detection module 530, screen analyzer module 550, withdrawal engine 555, or any combination thereof may be implemented on server 541. Any combination of these components may also be implemented on sending computing device 505.

In this manner, the illustrative embodiments permit a sending user to withdraw a message in semi-synchronous or instant messaging system that the sending user has sent to a recipient. Furthermore, because the sending user is notified as to whether the recipient has detected the message, the illustrative embodiments allow the sending user to withdraw the message without the recipient's knowledge. Thus, a sending user can avoid withdrawing a message that the recipient has already read.

Turning now to FIG. 6, a flowchart illustrating a process for preventing a set of users from accessing a message in an instant messaging system is depicted in accordance with an illustrative embodiment. The process illustrated in FIG. 6 may be implemented by an instant messaging application, such as instant messaging application 515 in FIG. 5. The process illustrated in FIG. 6 may also be implemented by software on a server, such as server 541 in FIG. 5.

The process begins by detecting receipt of a message at a receiving computing device (step 605). The process determines whether a message status request is received for the received message (step 610). If the process determines that a message status request is received for the received message, the process proceeds to step 620.

Returning to step 610, if the process determines that a message status request is not received for the received message, the process determines whether the receiving computing device is set to send notifications for all received messages (step 615). If the process determines that receiving computing device is not set to send notifications for all received messages, the process proceeds to step 630.

Returning to step 615, if the process determines that the receiving computing device is set to send notifications for all received messages, the process determines whether the user at receiving computing device has detected the received message (step 620). If the process determines that the user at receiving computing device has detected the received message, then the process proceeds to step 630.

Returning to step 620, if the process determines that the user at receiving computing device has not detected the received message, then the process notifies the sending computing device that the message is undetected (step 625).

The process determines whether a withdrawal request is received (step 630). If no withdrawal request is received, then the process terminates. Returning to step 630, if a withdrawal request is received, the process prevents the user at the receiving computing device from accessing the message (step 635). The process then terminates.

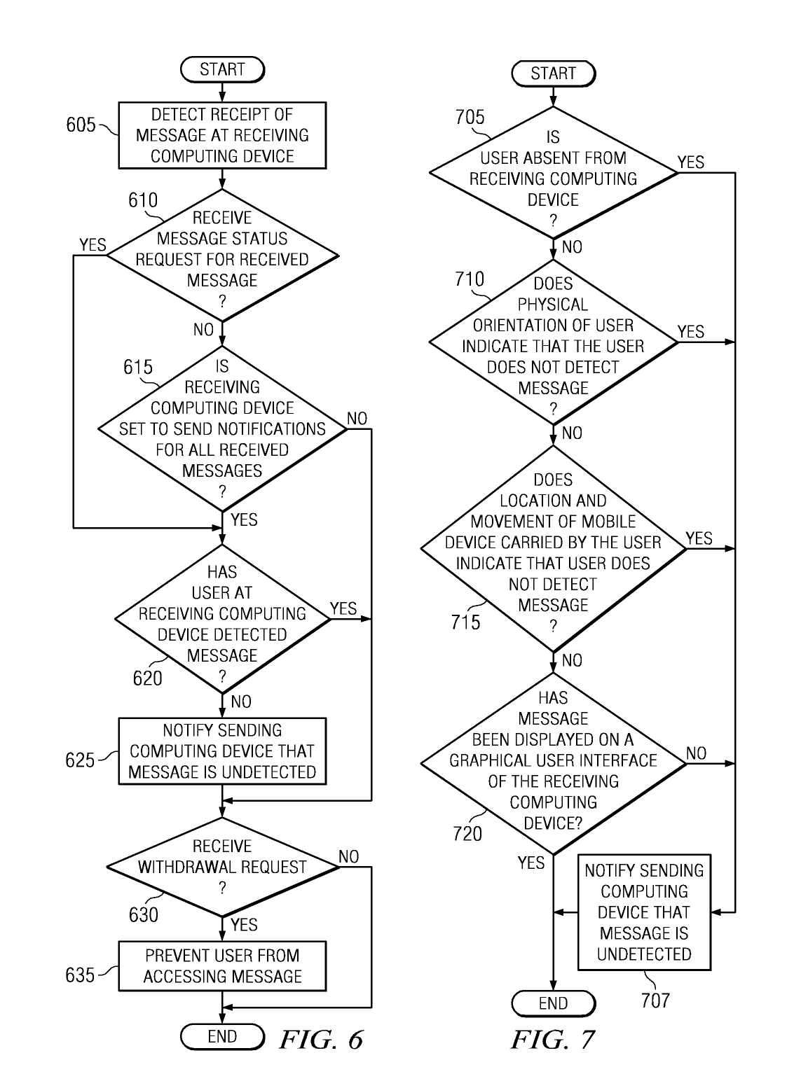

Turning now to FIG. 7, is a flowchart illustrating a process for preventing a set of users from accessing a message in an instant messaging system in accordance with an illustrative embodiment. The process illustrated in FIG. 7 may be implemented by an instant messaging application, such as instant messaging application 515 in FIG. 5. The process illustrated in FIG. 7 may also be implemented by software on a server, such as server 541 in FIG. 5. The process illustrated in FIG. 7 is also a non-limiting example of steps 620 and 625 in FIG. 6.

The process begins by determining whether a user associated with the receiving computing device is absent from the receiving computing device (step 705). If the process determines that the user associated with the receiving computing device is absent from the receiving computing device, the process notifies the sending computing device that the message is undetected (step 707). The process then terminates.

Returning to step 705, if the process determines that the user associated with the receiving computing device is not absent from the receiving computing device, the process determines whether the physical orientation of the user indicates that the user does not detect the message (step 710). If the process determines that the physical orientation of the user indicates that the user does not detect the message, then the process notifies the sending computing device that the message is undetected (step 707). The process then terminates.

Returning to step 710, if the process determines that the physical orientation of the user indicates that the user detects the message, then the process determines whether the location and movement of a mobile device carried by the user indicates that the user does not detect the message (step 715). If the process determines that the location and movement of a mobile device carried by the user indicates that the user does not detect the message, then the process notifies the sending computing device that the message is undetected (step 707). The process then terminates.

Returning to step 715, if the process determines that the location and movement of a mobile device carried by the user indicates that the user detects the message, then the process determines whether the message has been displayed on a graphical user interface of the receiving computing device (step 720). If the process determines that the message has not been displayed on a graphical user interface of the receiving computing device, then the process notifies the sending computing device that the message is undetected (step 707). The process then terminates. Returning to step 720, if the process determines that the message has been displayed on a graphical user interface of the receiving computing device, then the process terminates.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The illustrative embodiments described herein provide a computer-implemented method, apparatus, and computer program product for preventing a set of users from accessing a message in an instant messaging system. The process detects receipt of the message at a receiving computing device.

The process also notifies the sending computing device that the message is undetected by a set of users associated with the receiving computing device. The process may notify the sending computing device that the message is undetected by a set of users associated with the receiving computing device in response to determining that the message is undetected by the set of users. In one embodiment, the process that notifies the sending computing device that the message is undetected by a set of users associated with the receiving computing device, may also be in response to a message status request from the sending computing device.

The process may determine that the message is “undetected” by the set of users in a variety of ways. In one embodiment, the process determines that the message is undetected by the set of users by detecting an absence of the set of users at the receiving computing device.

In one example, the absence is detected by a visual or audio sensing device. In another example, an absence of the set of users at the receiving computing device is detected when the process detects an absence of a mobile device carried by the user.

In another embodiment, the process determines that the message is undetected by the set of users by detecting a location and movement of the mobile device carried by the set of users. The process uses the detected location and movement of the mobile device to determine that the message is undetected by the set of users. For example, the process may detect that the mobile device is moving away from the receiving computing device at a location beyond a viewing distance between the set of users and receiving computing device. In another example, the location and the movement are detected using Bluetooth.

In another embodiment, the process determines that the message is undetected by the set of users by identifying a physical orientation of the set of users. A physical orientation is the location and movement of the body parts of the set of users. The physical orientation may be identified by a visual sensing device. In this embodiment, the process determines that the message is undetected by the set of users based on the physical orientation of the set of users. For example, the process may determine that the message is undetected by the set of users if the physical orientation of the set of users indicates that the set of users is not looking at a graphical user interface of the receiving computing device. A visual sensing device may be used in this example in such a way that the visual sensing device can detect whether the eyes of the set of users are directed away from the graphical user interface.

In another embodiment, the process determines that the message is undetected by the set of users by determining that the message is not displayed on a graphical user interface on the receiving computing device. For example, the message may not be displayed on a graphical user interface on the receiving computing device because the dialog windows containing the message are minimized. In this example, the dialog windows may also be concealed or partially concealed by another window, a screen saver, or any other graphical object on the graphical user interface. In another embodiment, the process may determine that the message is not displayed on the graphical user interface on the receiving computing device by determining that a graphical display for the instant messaging system is not displayed on the graphical user interface.

The process also prevents the set of users associated with the receiving computing device from accessing the message in response to receiving a request to prevent the set of users from accessing the message. In one embodiment, the process prevents the set of users associated with the receiving computing device from accessing the message by preventing the set of users from accessing the message on a graphical user interface. In another embodiment, the process prevents the set of users associated with the receiving computing device from accessing the message by removing the message from the graphical user interface. For example, the message may be removed from an ‘inbox’ of the instant messaging application at the receiving computing device.

Existing processes only allow a user to withdraw a message on an asynchronous messaging system, and do not provide any way to determine, in real time, whether a recipient has detected a message in a semi-synchronous or instant messaging environment. Also, some existing processes only address ways to avoid sending an undesirable message before the message is sent. However, the illustrative embodiments permit a sending user to withdraw a message in a semi-synchronous or instant messaging system that the sending user has sent to a recipient. Furthermore, because the sending user is notified as to whether the recipient has detected the message, the illustrative embodiments allow the sending user to withdraw the message without the recipient's knowledge. Thus, a sending user can avoid withdrawing a message that the recipient has already read, and thereby avoid alerting the recipient to the sending user's withdrawal of the message.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented method for managing messages in an instant messaging system, comprising:
determining whether a message received by a receiving computing device from a sending computing device is undetected by a set of users associated with the receiving computing device;
responsive to determining that the message is undetected by the set of users associated with the receiving computing device, notifying the sending computing device that the message is undetected by the set of users; and
responsive to receiving a request to prevent the set of users from accessing the message, preventing the set of users from accessing the message.

2. The computer-implemented method of claim 1, wherein preventing the set of users from accessing the message, further comprises:
preventing the set of users from accessing the message on a graphical user interface.

3. The computer-implemented method of claim 2, wherein preventing the set of users from accessing the message on the graphical user interface further comprises:
removing the message from the graphical user interface.

4. The computer-implemented method of claim 1, wherein determining that the message is undetected by the set of users further comprises:
detecting an absence of the set of users at the receiving computing device.

5. The computer-implemented method of claim 4, wherein the absence is detected based on user data that is acquired by a visual sensing device.

6. The computer-implemented method of claim 4, wherein the absence is detected based on user data that is acquired by an audio sensing device.

7. The computer-implemented method of claim 4, wherein detecting an absence of the set of users at the receiving computing device further comprises:
detecting the absence of a mobile device carried by the set of users.

8. The computer-implemented method of claim 1, wherein determining that the message is undetected by the set of users further comprises:
identifying a physical orientation of the set of users; and
determining that the message is undetected by the set of users based on the physical orientation.

9. The computer-implemented method of claim 1, wherein determining that the message is undetected by the set of users further comprises:
detecting a location and a movement of a mobile device carried by the set of users; and
determining that the message is undetected by the set of users based on the location and the movement.

10. The computer-implemented method of claim 9, wherein the location and the movement are detected using bluetooth.

11. The computer-implemented method of claim 1, wherein determining that the message is undetected by the set of users further comprises:
determining that the message is not displayed on a graphical user interface on the receiving computing device.

12. The computer-implemented method of claim 11, wherein determining that the message is not displayed on the graphical user interface on the receiving computing device further comprises:
determining that a graphical display for the instant messaging system is not displayed on the graphical user interface.

13. The computer-implemented method of claim 1, wherein the notifying is in response to a message status request from the sending computing device.

14. A computer program product comprising:
a computer-usable medium having computer-usable program code for managing messages in an instant messaging system, the computer program product comprising:
computer-usable program code for determining whether a message received by a receiving computing device from a sending computing device is undetected by a set of users associated with the receiving computing device;
computer-usable program code, responsive to determining that the message is undetected by the set of users associated with the receiving computing device, for notifying the sending computing device that the message is undetected by the set of users; and
computer-usable program code, responsive to receiving a request to prevent the set of users from accessing the message, for preventing the set of users from accessing the message.

15. The computer program product of claim 14, wherein the computer-usable program code for preventing the set of users from accessing the message on the graphical user interface further comprises:
computer-usable program code for removing the message from the graphical user interface.

16. The computer program product of claim 14, wherein determining that the message is undetected by the set of users further comprises:
computer-usable program code for detecting an absence of the set of users at the receiving computing device.

17. The computer program product method of claim 14, wherein determining that the message is undetected by the set of users further comprises:
computer-usable program code for determining that the message is not displayed on a graphical user interface on the receiving computing device.

18. A data processing system comprising:
a bus system;
a memory connected to the bus system, wherein the memory includes a set of instructions; and
a processing unit connected to the bus system, wherein the processing unit executes the set of instructions to determine whether a message received by a receiving computing device from a sending computing device is undetected by a set of users associated with the receiving computing device; notify the sending computing device that the message is undetected by the set of users in response to determining that the message is undetected by the set of users associated with the receiving computing device; and prevent the set of users from accessing the message in response to receiving a request to prevent the set of users from accessing the message.

19. The data processing system of claim 18, wherein in determining that the message is undetected by the set of users, the processing unit further executes the set of instructions to:
detect an absence of the set of users at the receiving computing device.

20. The data processing system of claim 18, wherein in determining that the message is undetected by the set of users, the processing unit further executes the set of instructions to:
determine that the message is not displayed on a graphical user interface on the receiving computing device.
